(19) United States
(12) Patent Application Publication
(10) Pub. No.: US 2025/0304164 A1
(43) Pub. Date: Oct. 2, 2025

(54) VEHICLE

(71) Applicant: SUBARU CORPORATION, Tokyo (JP)

(72) Inventor: Yuto OHASHI, Tokyo (JP)

(73) Assignee: SUBARU CORPORATION, Tokyo (JP)

(21) Appl. No.: 19/052,496

(22) Filed: Feb. 13, 2025

(30) Foreign Application Priority Data
Mar. 28, 2024 (JP) 2024-052813

(51) Int. Cl. B62D 15/02

(52) U.S. Cl. CPC B62D 15/025

(57) ABSTRACT

A vehicle includes: a steering-wheel holding state detector configured to detect a steering-wheel holding state of a steering wheel by a driver who drives the vehicle; a traveling state detector configured to detect a traveling state of the vehicle; a torque detector configured to detect a torsion-bar-torque value of the steering wheel; and a controller configured to perform an override determination based on the torsion-bar-torque value and a torsion-bar-torque threshold value that is set based on the steering-wheel holding state and the traveling state.

### CROSS-REFERENCE TO RELATED APPLICATIONS

The present application claims priority from Japanese Patent Application No. 2024-052813 filed on Mar. 28, 2024, the entire contents of which are hereby incorporated by reference.

### BACKGROUND

The present disclosure relates to a vehicle.

In recent years, a vehicle has been in practical use that is equipped with a function of advanced driver assistance systems (ADAS) in which the vehicle itself grasps information on the surroundings of the vehicle and controls the vehicle in place of a driver who drives the vehicle.

One example of the ADAS function in which the vehicle manipulates a steering wheel in place of the driver is a lane keeping system (LKS) that controls the steering wheel such that the vehicle does not depart from a vehicle traffic lane in which the vehicle is traveling so as to maintain the traveling position of the vehicle near the center of the vehicle traffic lane. As this type of technology, a technology has been proposed (e.g., see Japanese Unexamined Patent Application Publication (JP-A) No. 2016-159781) in which a torsion-bar-torque value is monitored while the vehicle is manipulating the steering wheel and controlling the traveling position. When the torsion-bar-torque value has exceeded a predetermined threshold value, it is determined that the driver has forcibly intervened and performed a steering wheel operation, such as turning right or left or changing lanes (override determination). Then, steering wheel control is turned off and the driver's steering wheel operation is prioritized.

### SUMMARY

Form 1: One or more embodiments of the present disclosure propose a vehicle including: a steering-wheel holding state detector configured to detect a steering-wheel holding state of a steering wheel by a driver who drives the vehicle; a traveling state detector configured to detect a traveling state of the vehicle; a torque detector configured to detect a torsion-bar-torque value of the steering wheel; and a controller configured to perform an override determination based on the torsion-bar-torque value and a torsion-bar-torque threshold value that is set based on the steering-wheel holding state and the traveling state.

Form 2: One or more embodiments of the present disclosure propose a vehicle including circuitry configured to: detect a torsion-bar-torque value of the steering wheel; detect a steering-wheel holding state of a steering wheel by a driver who drives the vehicle; detect a traveling state of the vehicle; and perform an override determination based on the torsion-bar-torque value and a torsion-bar-torque threshold value that is set based on the steering-wheel holding state and the traveling state.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view illustrating the configuration of a vehicle according to an embodiment of the present disclosure;

FIG. 2 is a view illustrating a flow of an override determination process of the vehicle according to the embodiment of the present disclosure; and

FIG. 3 is a view illustrating torsion-bar-torque threshold values set by a controller of the vehicle according to the embodiment of the present disclosure.

### DETAILED DESCRIPTION

During execution of the ADAS function in which the vehicle manipulates the steering wheel in place of the driver, a steering shaft is rotated by a motor. In this case, if the driver holds the steering wheel, torsion occurs in the steering shaft. During traveling along a curve, a driving force of the motor becomes larger and the torsion occurring in the steering shaft also becomes larger than during traveling along a straight road. Accordingly, the torsion-bar-torque value during traveling along a curve becomes a larger value than the torsion-bar-torque value during traveling along a straight road. When the driver's forcible intervention (override) is determined based on whether the torsion-bar-torque value has exceeded a threshold value, a steering force to be applied per hand differs depending on a steering-wheel holding state (one-handed steering wheel holding or both-handed steering wheel holding) at the time of the driver's steering wheel operation.

In the above-described technology described in JP-A No. 2016-159781, however, regardless of the traveling state of the vehicle or the steering-wheel holding state of the driver, when the torsion-bar-torque value has exceeded the predetermined threshold value, the steering wheel control is turned off and the driver's steering wheel operation is prioritized. This raises a problem that, depending on the traveling state of the vehicle or the steering-wheel holding state of the driver, an override is determined despite the driver having no intention of overriding.

It is desirable to provide a vehicle that performs an accurate override determination adapted to changes in a traveling state of the vehicle and a steering-wheel holding state of a driver.

### Embodiments

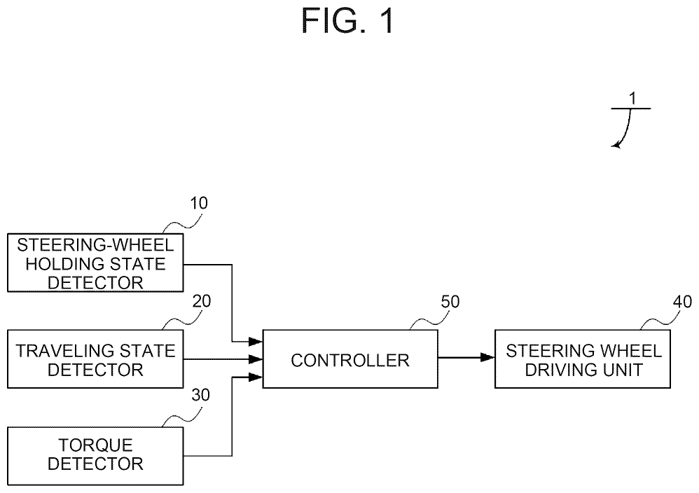

A vehicle 1 according to an embodiment will be described using FIG. 1 to FIG. 3. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

### Configuration of Vehicle 1

As illustrated in FIG. 1, the vehicle 1 according to the embodiment is configured to include a steering-wheel holding state detector 10, a traveling state detector 20, a torque detector 30, a steering wheel driving unit 40, and a controller 50.

The steering-wheel holding state detector 10 detects a steering-wheel holding state of a steering wheel by a driver who drives the vehicle 1. The steering-wheel holding state detector 10 detects whether the steering-wheel holding state of the driver is one-handed steering wheel holding, both-handed steering wheel holding, or no steering wheel holding. For example, the steering-wheel holding state detector 10 detects the steering-wheel holding state of the steering wheel by the driver based on, for example, a sensor output of a touch sensor, a grasping force sensor, or the like that is provided at least on each of right and left sides of the steering wheel, and transmits the detection result to the controller 50 to be described later. In one example, when the sensor output on either the right or left side is larger than a predetermined threshold value, the steering-wheel holding state detector 10 determines that the steering-wheel holding state of the driver is “one-handed steering wheel holding,” and when the sensor outputs on both the right and left sides are larger than the predetermined threshold value, the steering-wheel holding state detector 10 determines that the steering-wheel holding state of the driver is “both-handed steering wheel holding.” When the sensor outputs on both the right and left sides are smaller than the predetermined threshold value, the steering-wheel holding state detector 10 determines that the steering-wheel holding state of the driver is “no steering wheel holding.” It is sufficient for the steering-wheel holding state detector 10 to detect whether the steering-wheel holding state of the steering wheel by the driver is one-handed steering wheel holding, both-handed steering wheel holding, or no steering wheel holding, and therefore the steering-wheel holding state detector 10 may detect the steering-wheel holding state of the driver based on, for example, an image of the driver captured by a driver monitoring system, a drive recorder, or the like.

The traveling state detector 20 detects a traveling state of the vehicle 1. The traveling state detector 20 detects whether the traveling state of the vehicle 1 is traveling along a curve or traveling along a straight road. For example, the traveling state detector 20 calculates a curvature of a road on which the vehicle 1 is currently traveling based on, for example, an image captured of surroundings of the vehicle 1 or a measurement result of a light detection and ranging (LiDAR). Based on that curvature, the traveling state detector 20 detects whether the traveling state of the vehicle 1 is traveling along a curve or traveling along a straight road, and transmits the detection result to the controller 50 to be described later. In one example, when the calculated curvature is larger than a predetermined curvature, the traveling state detector 20 determines that the traveling state of the vehicle 1 is “traveling along a curve,” and when the calculated curvature is smaller than the predetermined curvature, the traveling state detector 20 determines that the traveling state of the vehicle 1 is “traveling along a straight road.” It is sufficient for the traveling state detector 20 to detect whether the traveling state of the vehicle 1 is traveling along a curve or traveling along a straight road, and therefore the traveling state detector 20 may detect the traveling state of the vehicle 1 based on, for example, a sensor output of a yaw rate sensor, a gyroscope sensor, or a steering-wheel steered angle sensor.

The torque detector 30 detects a torsion-bar-torque value. For example, the torque detector 30 detects an amount of torsion of a torsion bar of the steering wheel of the vehicle 1 (torsion-bar-torque value) by, for example, a torque sensor provided on the torsion bar, and transmits the detection result to the controller 50.

The steering wheel driving unit 40 rotates the steering wheel according to a control signal from the controller 50 to be described later. For example, the steering wheel driving unit 40 is configured to include a motor that rotates the steering wheel, and drives the motor according to a control signal (information on the steered angle of the steering wheel and the like) received from the controller 50 to be described later, and applies a driving force of the steering shaft to the steering wheel to thereby rotate the steering wheel.

The controller 50 controls the operation of the entire vehicle 1 according to a control program stored in an ROM and the like (not illustrated). In the embodiment of the present disclosure, the controller 50 performs an override determination based on the torsion-bar-torque value and a torsion-bar-torque threshold value that is set based on the steering-wheel holding state and the traveling state. For example, the controller 50 sets the torsion-bar-torque threshold value for performing the override determination based on the steering-wheel holding state of the steering wheel by the driver (one-handed steering wheel holding, both-handed steering wheel holding, or no steering wheel holding) received from the steering-wheel holding state detector 10 and on the traveling state of the vehicle 1 (traveling along a curve or traveling along a straight road) received from the traveling state detector 20, compares the torsion-bar-torque threshold value and the current torsion-bar-torque value received from the torque detector 30, and determines whether a steering wheel operation has been performed by the driver. In the present embodiment, the controller 50 executes steering wheel control by a lane keeping system (LKS) that maintains a traveling position of the vehicle 1 near the center of a vehicle traffic lane. For example, the controller 50 controls the traveling position of the vehicle 1 by detecting a lane line that indicates a vehicle traffic lane, for example, from an image captured of a front side of the vehicle 1, and transmitting a control signal to the steering wheel driving unit 40 such that the traveling position of the vehicle 1 is near a center of the vehicle traffic lane. When the controller 50 determines that the driver has forcibly intervened and performed a steering wheel operation while the LKS is in operation (override determination), the controller 50 stops the steering wheel control by the LKS and switches to steering wheel control that prioritizes the driver's steering wheel operation. Details of an override determination process will be described below.

### Override Determination Process

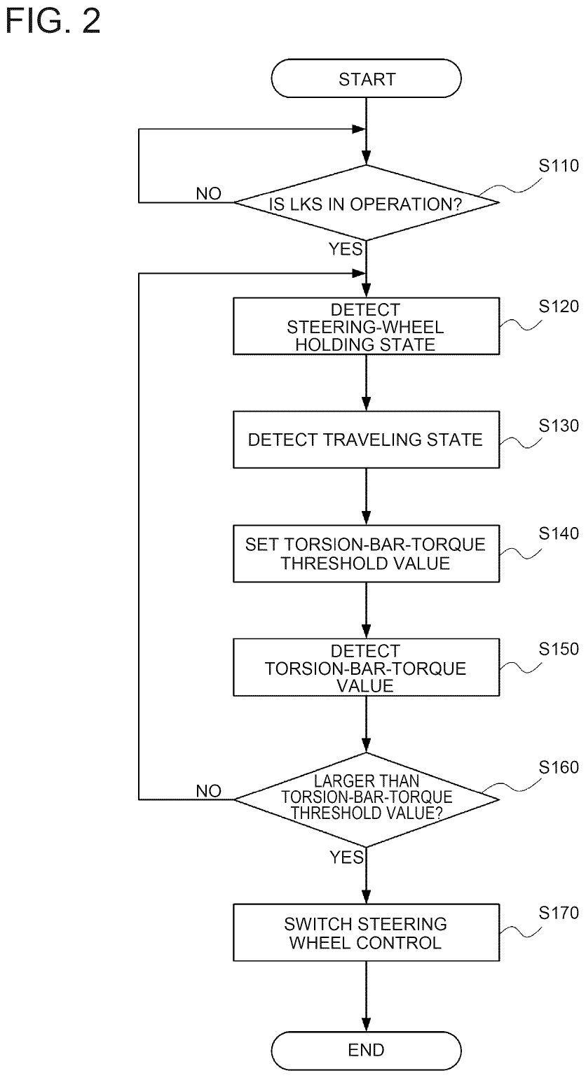

The override determination process of the vehicle 1 will be described using FIG. 2

As illustrated in FIG. 2, the controller 50 determines whether the LKS is in operation (step S110). For example, the controller 50 determines whether the LKS is in operation by detecting, for example, a state of a switch for turning the LKS on and off that is provided in the vehicle 1. When the controller 50 determines that the LKS is not in operation (“NO” in step S110), the controller 50 returns the process to the original state and transitions to a standby state.

On the other hand, when the controller 50 determines that the LKS is in operation (“YES” in step S110), the steering-wheel holding state detector 10 detects whether the steering-wheel holding state of the steering wheel by the driver is one-handed steering wheel holding, both-handed steering wheel holding, or no steering wheel holding (step S120).

The traveling state detector 20 detects whether the traveling state of the vehicle 1 is traveling along a curve or traveling along a straight road (step S130).

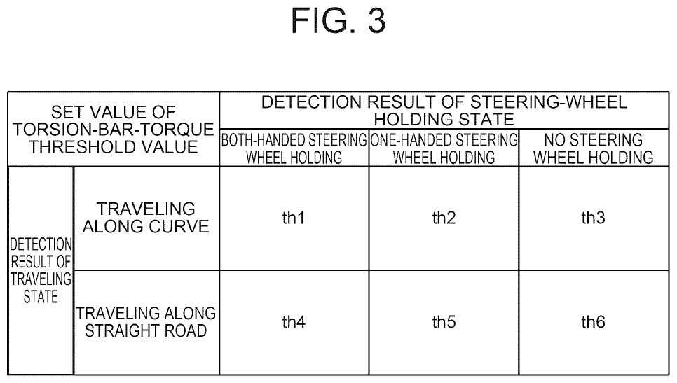

The controller 50 executes a torsion-bar-torque threshold value setting process (step S140). For example, the controller 50 sets one value among th1 to th6 as the torsion-bar-torque threshold value based on the steering-wheel holding state of the driver received from the steering-wheel holding state detector 10 (step S120) and the traveling state of the vehicle 1 received from the traveling state detector 20 (step S130). As illustrated in FIG. 3, when the steering-wheel holding state of the driver is “both-handed steering wheel holding” and the traveling state of the vehicle 1 is “traveling along a curve,” the torsion-bar-torque threshold value is set to th1. When the steering-wheel holding state of the driver is “one-handed steering wheel holding” and the traveling state of the vehicle 1 is “traveling along a curve,” the torsion-bar-torque threshold value is set to th2. When the steering-wheel holding state of the driver is “no steering wheel holding” and the traveling state of the vehicle 1 is “traveling along a curve,” the torsion-bar-torque threshold value is set to th3. When the steering-wheel holding state of the driver is “both-handed steering wheel holding” and the traveling state of the vehicle 1 is “traveling along a straight road,” the torsion-bar-torque threshold value is set to th4. Further, when the steering-wheel holding state of the driver is “one-handed steering wheel holding” and the traveling state of the vehicle 1 is “traveling along a straight road,” the torsion-bar-torque threshold value is set to th5. When the steering-wheel holding state of the driver is “no steering wheel holding” and the traveling state of the vehicle 1 is “traveling along a straight road,” the torsion-bar-torque threshold value is set to th6. Details of the set value of the above-described torsion-bar-torque threshold values (th1 to th6) will be described later.

The torque detector 30 detects the current torsion-bar-torque value of the vehicle 1 (step S150).

The controller 50 determines whether the torsion-bar-torque value received from the torque detector 30 is larger than the torsion-bar-torque threshold value set in step S140 (step S160). When the controller 50 determines that the torsion-bar-torque value received from the torque detector 30 is smaller than the torsion-bar-torque threshold value set in step S140 (“NO” in step S160), the controller 50 returns to the process in step S120. On the other hand, when the controller 50 determines that the torsion-bar-torque value received from the torque detector 30 is larger than the torsion-bar-torque threshold value set in step S140 (“YES” in step S160), the controller 50 stops the steering wheel control by the LKS and switches to control that prioritizes the driver's steering wheel operation (step S170), and ends the override determination process.

### Set Value of Torsion-Bar-Torque Threshold Value

The set value of the above-described torsion-bar-torque threshold values (th1 to th6) will be described. During traveling along a curve, the driving force of the motor that rotates the steering wheel becomes larger, and accordingly torsion occurring in the steering shaft becomes larger, than during traveling along a straight road. Therefore, to accurately determine whether the driver has intentionally performed a steering wheel operation (override determination), the value of the torsion-bar-torque threshold value may be changed according to the traveling state of the vehicle (traveling along a curve or traveling along a straight road). For example, the torsion-bar-torque threshold values (th1, th2) that are set to perform the override determination during traveling along a curve are set to larger values than the torsion-bar-torque threshold values (th4, th5) that are set to perform the override determination during traveling along a straight road. Thus, the torsion-bar-torque threshold values are set such that th1>th4 and th2>th5 hold true.

When the driver's forcible intervention (override) is determined based on whether the torsion-bar-torque value has exceeded the torsion-bar-torque threshold value, a steering force to be applied per hand differs depending on the steering-wheel holding state (one-handed steering wheel holding or both-handed steering wheel holding) at the time of the driver's steering wheel operation. When forcibly intervening and performing a steering wheel operation, the driver generally performs the steering wheel operation by both-handed steering wheel holding rather than one-handed steering wheel holding. Therefore, to make a setting such that an override is less likely to be determined when the steering-wheel holding state is “one-handed steering wheel holding” than when the steering-wheel holding state is “both-handed steering wheel holding,” the torsion-bar-torque threshold values (th2, th5) that are set when the steering-wheel holding state is one-handed steering wheel holding are set to larger values than the torsion-bar-torque threshold values (th1, th4) that are set when the steering-wheel holding state is both-handed steering wheel holding. Thus, the torsion-bar-torque threshold values are set such that th2>th1 and th5>th4 hold true.

When the steering-wheel holding state of the driver is “no steering wheel holding,” to avoid torsion of the torsion bar due to a reaction from a road surface or the like leading to an incorrect determination that an override operation has been executed, the torsion-bar-torque threshold values (th3, th6) that are set when the steering-wheel holding state is no steering wheel holding are set to larger values than the torsion-bar-torque threshold values (th2, th5) that are set when the steering-wheel holding state is one-handed steering wheel holding. Thus, the torsion-bar-torque threshold values are set such that th3>th2 and th6>th5 hold true. As has been described above, the values of the torsion-bar-torque threshold values are set such that, for example, th3>th2>th1>th6>th5>th4 holds true.

While the description has been given above by showing, as an example, the override determination process while the LKS of the vehicle 1 is in operation, the above-described override determination process may be executed, for example, while autonomous driving that autonomously controls manipulation of the steering wheel is in operation, and when it is determined that the driver has forcibly intervened and performed a steering wheel operation (override determination), the autonomous driving may be switched to control that prioritizes the driver's steering wheel operation.

### Workings and Advantages

As has been described above, the controller 50 of the vehicle 1 according to the embodiment executes the override determination based on the current torsion-bar-torque value that is received from the torque detector 30 and on the torsion-bar-torque threshold value that is set based on the steering-wheel holding state of the driver received from the steering-wheel holding state detector 10 and the traveling state of the vehicle 1 received from the traveling state detector 20. When the controller 50 determines that the torsion-bar-torque value is larger than the torsion-bar-torque threshold value, the controller 50 determines that the driver has forcibly intervened and performed a steering wheel operation, such as turning right or left or changing lanes. That is, since the torsion-bar-torque value changes significantly according to the steering-wheel holding state of the driver and the traveling state of the vehicle 1, the controller 50 executes the override determination while changing the value of the torsion-bar-torque threshold value for performing the override determination according to the steering-wheel holding state of the driver and the traveling state of the vehicle. Thus, the vehicle 1 can perform an accurate override determination adapted to changes in the traveling state of the vehicle and the steering-wheel holding state of the driver.

The steering-wheel holding state detector 10 detects whether the steering-wheel holding state of the driver is one-handed steering wheel holding, both-handed steering wheel holding, or no steering wheel holding. The traveling state detector 20 detects whether the traveling state of the vehicle 1 is traveling along a curve or traveling along a straight road. During execution of the ADAS function that performs control of manipulation of the steering wheel in place of the driver, the steering shaft is rotated by the motor. When the driver holds the steering wheel during execution of the above-described ADAS function, torsion occurs in the steering shaft. During traveling along a curve, the driving force of the motor becomes larger, and accordingly the torsion occurring in the steering shaft also becomes larger, than during traveling along a straight road. Therefore, the torsion-bar-torque value during traveling along a curve becomes a larger value than the torsion-bar-torque value during traveling along a straight road. In the case where the driver forcibly intervenes (overrides) and operates the steering wheel during execution of the ADAS function (during execution of the LKS), the steering force to be applied per hand differs depending on the steering-wheel holding state of the driver (one-handed steering wheel holding or both-handed steering wheel holding). That is, since the torsion-bar-torque value changes significantly according to the traveling state of the vehicle 1 and the steering-wheel holding state of the steering wheel by the driver, the controller 50 performs the override determination while changing the torsion-bar-torque threshold value for determining an override based on the traveling state of the vehicle (traveling along a curve or traveling along a straight road) and the steering-wheel holding state of the driver (one-handed steering wheel holding, both-handed steering wheel holding, or no steering wheel holding). Thus, an accurate override determination adapted to changes in the traveling state of the vehicle and the steering-wheel holding state of the driver can be performed, so that an incidence of determination of an override not intended by the driver can be suppressed.

### Modified Example 1

While the above-described controller 50 sets the torsion-bar-torque threshold value based on the traveling state (traveling along a curve or traveling along a straight road), the torsion-bar-torque threshold value may be set for each curvature of a road being traveled. That is, since the value of the torsion-bar-torque value changes significantly according to the curvature of the road being traveled, the controller 50 may set the torsion-bar-torque threshold value according to the curvature of the road and the steering-wheel holding state of the driver. Thus, the torsion-bar-torque threshold value can be set more finely, which allows for performing an even more accurate override determination.

The vehicle 1 according to the embodiment of the present disclosure can be realized by recording the processes of the steering-wheel holding state detector 10, the traveling state detector 20, the controller 50 and the like in a recording medium that is readable by a computer system serving the steering-wheel holding state detector 10, the traveling state detector 20, and the controller 50, and making the computer system retrieve and execute a program recorded in the recording medium. The term “computer system” here includes an OS and hardware, such as peripheral devices.

The term “computer system” also includes a home page provision environment (or display environment) when the World Wide Web (WWW) system is used. The program may be transmitted from the computer system that stores the program in a storage device or the like to another computer system via a transmission medium or by transmission waves in a transmission medium. Here, the term “transmission medium” that transmits the program refers to a medium having a function of transmitting information like a network (communication network), such as the Internet, or a communication line (communication wire), such as a telecommunication line.

The program may be one for realizing some of the above-described functions. Further, the program may be one that can realize the above-described functions by being combined with a program that has been already recorded in the computer system, i.e., a differential file (differential program).

While embodiments of the present disclosure have been described in detail above with reference to the drawings, all vehicles that those skilled in the art can implement by making design changes as appropriate based on the vehicle described above as an embodiment of the present disclosure also belong to the applicable scope of embodiments of the present disclosure, as long as such vehicles embrace the gist of the present disclosure. Within the range of the idea of the present disclosure, any person skilled in the art can conceive various altered examples and adjusted examples, and it is understood that such altered examples and adjusted examples also belong to the applicable scope of embodiments of the present disclosure. For example, embodiments that those skilled in the art obtain by making additions, omissions, or design changes of constituent elements, or making additions, omissions, or changes of conditions of steps, relative to the above-described embodiments are also included in the applicable scope of embodiments of the present disclosure, as long as such embodiments include the gist of the present disclosure.

It is understood that other workings and advantages produced by the aspects described in the embodiment that are obvious from the description in the present specification or that those skilled in the art can conceive as appropriate are naturally produced by embodiments of the present disclosure. Various embodiments can be formed by appropriately combining multiple constituent elements disclosed in the embodiments. For example, some constituent elements may be omitted from all the constituent elements shown in the embodiments. Further, constituent elements belonging to different embodiments may be combined as appropriate. The steering-wheel holding state detector 10, the traveling state detector 20, the torque detector 30, and the controller 50 illustrated in FIG. 1 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the steering-wheel holding state detector 10, the traveling state detector 20, the torque detector 30, and the controller 50 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the steering-wheel holding state detector 10, the traveling state detector 20, the torque detector 30, and the controller 50 illustrated in FIG. 1.

What is claimed is:

1. A vehicle comprising:
a steering-wheel holding state detector configured to detect a steering-wheel holding state of a steering wheel by a driver who drives the vehicle;
a traveling state detector configured to detect a traveling state of the vehicle;
a torque detector configured to detect a torsion-bar-torque value of the steering wheel; and
a controller configured to perform an override determination based on the torsion-bar-torque value and a torsion-bar-torque threshold value that is set based on the steering-wheel holding state and the traveling state.

2. The vehicle according to claim 1, wherein the steering-wheel holding state detector is configured to detect whether the steering-wheel holding state of the driver is one-handed steering wheel holding, both-handed steering wheel holding, or no steering wheel holding.

3. The vehicle according to claim 1, wherein the traveling state detector is configured to detect whether the traveling state of the vehicle is traveling along a curve or traveling along a straight road.

4. The vehicle according to claim 2, wherein the traveling state detector is configured to detect whether the traveling state of the vehicle is traveling along a curve or traveling along a straight road.

5. A vehicle comprising circuitry configured to
detect a torsion-bar-torque value of a steering wheel,
detect a steering-wheel holding state of a steering wheel by a driver who drives the vehicle,
detect a traveling state of the vehicle, and
perform an override determination based on the torsion-bar-torque value and a torsion-bar-torque threshold value that is set based on the steering-wheel holding state and the traveling state.
